(19) United States
(12) Patent Application Publication
(10) Pub. No.: US 2026/0110557 A1
(43) Pub. Date: Apr. 23, 2026

(54) Multi-Sensor Approach for Fiber-Based Manhole/Handhole Localization and Condition Monitoring

(71) Applicant: NEC Laboratories America, Inc., Princeton, NJ (US)

(72) Inventors: Ming-Fang Huang, Princeton, NJ (US); Shaobo Han, Princeton, NJ (US)

(73) Assignee: NEC Laboratories America, Inc., Princeton, NJ (US)

(21) Appl. No.: 19/360,905

(22) Filed: Oct. 16, 2025

Related U.S. Application Data
(60) Provisional application No. 63/708,329, filed on Oct. 17, 2024.

(51) Int. Cl. G01D 5/353; G01H 9/00; G01K 3/00; G01K 11/324; G01K 15/00

(52) U.S. Cl. CPC G01D 5/35361; G01H 9/004; G01K 3/005; G01K 11/324; G01K 15/007

(57) ABSTRACT

An integrated Distributed Fiber Optic Sensing (DFOS) system and method that combines Distributed Acoustic Sensing (DAS) and Distributed Temperature Sensing (DTS) that provides enhanced manhole/handhole (MH/HH) localization, condition diagnostics, and anomaly detection. The system and method leverages the capabilities of both sensing methods: DAS utilizes ambient noise and machine learning (ML) for acoustic signature identification, while DTS utilizes day/night temperature variations. This combined approach significantly improves MH localization accuracy from an initial value of standalone systems by cross-referencing DAS and DTS data.

### CROSS REFERENCE TO RELATED APPLICATIONS

This application claims the benefit of U.S. Provisional Patent Application Ser. No. 63/708,329 filed Oct. 17, 2024, the entire contents of which is incorporated by reference as if set forth at length herein.

### FIELD OF THE INVENTION

This application relates generally to distributed fiber optic sensing (DFOS) systems and methods. More particularly, it pertains to an integrated Distributed Acoustic Sensing (DAS)/Distributed Temperature (DTS) system and method for manhole/hand hole (MH/HH) localization, condition diagnostics and anomaly detection.

### BACKGROUND OF THE INVENTION

Distributed Acoustic Sensing (DAS) is a DFOS technology that uses fiber optic cables to detect acoustic vibrations. Its unique ability to detect small vibrations over long distances in real-time makes it an invaluable tool for monitoring and protecting critical infrastructures such as railroads, telecommunications networks, bridges, roads and electrical power generation and distribution systems.

Optical fiber cables, originally designed for telecommunications, are increasingly being repurposed for ambient environmental monitoring using DFOS technologies including DAS and DTS. In deployed fiber optic telecommunications networks, a significant length of the fiber optic cable is buried underground, and extra cable length (or “slack”) is intentionally stored coiled in manholes. As a result, it is essential that carriers, operators, and service providers accurately locate these manholes for maintenance purposes. However, due to ongoing changes in fiber optic cable deployments, such as branching, additional connections, and the incorporation of extra fibers, relying solely on a database and optical time-domain reflectometry (OTDR) techniques to locate the manholes will oftentimes result in poor manhole localization.

### SUMMARY OF THE INVENTION

The above problem is solved and an advance in the art is made according to aspects of the present disclosure directed to an innovative approach to manhole/hand hole (MH/HH) localization that employs an integrated DFOS system and method that combines distributed acoustic sensing (DAS) with distributed temperature sensing (DTS) such that MH/HH that are perpetually flooded are located with improved accuracy as compared with prior approaches.

As we shall show and describe and in sharp contrast to the prior art, our inventive system and method provides the following.

Enhanced Detection Accuracy: Combining DAS and DTS data provides more precise localization of manholes (MH) and handholes (HH), while further providing a dual verification through both acoustic and temperature signatures, thereby reducing false positives while improving overall accuracy.

Reduced Field Labor: By utilizing ambient noise (DAS) and natural temperature variations (DTS) as sensing inputs, our inventive system and method reduces or eliminates labor-intensive fieldwork, leading to more efficient monitoring without manual inspections or disruptions.

Real-Time Data Insights: Our inventive system and method delivers continuous, real-time data on MH/HH conditions, such as whether they are dry, flooded, or iced-allowing field technicians to prepare necessary equipment in advance based on current conditions, thereby saving time and enhancing operational efficiency.

Long-Term Monitoring: Our inventive integrated DAS/DTS system and method monitors buried and/or aerial cables over long periods of time, providing early warnings of potential issues, such as abnormal temperature changes or external noise interference that could indicate potential damage.

AI-Enhanced Analysis: Our inventive system and method integrates machine learning algorithms with a DAS/DTS system and method enhances the detection of data patterns, thereby improving the accuracy of event detection and anomaly identification.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic flow diagram showing illustrative overall procedure of integrated DFOS/DAS/DTS system and method according to aspects of the present disclosure.

FIG. 3 is a schematic diagram showing illustrative integrated DAS/DTS system according to aspects of the present disclosure.

FIG. 4(A), FIG. 4(B), FIG. 4(C), FIG. 4(D), and FIG. 4(E), series of illustrations of: FIG. 4(A)-4(D) waterfall images; and FIG. 4(E) phase correlation from waveform signals according to aspects of the present invention.

FIG. 5 is a plot of Manhole Position vs Temperature Variation vs Distance of observed MH/HH locations determined by DTS according to aspects of the present disclosure.

FIG. 6 is a tabular presentation of ML results, MH/HH Conditions, Cable Sections, and Anomaly Events for DAS and DTS according to aspects of the present disclosure.

FIG. 7 shows an illustrative feature diagram in hierarchical format of an integrated DFOS/DAS/DTS system and method according to aspects of the present invention.

FIG. 8 is a schematic diagram showing illustrative experimental setup up an integrated DAS/DTS system according to aspects of the present disclosure.

FIG. 9 are a pair of plots showing illustrative test beds in Richardson, TX (left) and Long Beach Island, NJ (Right) according to aspects of the present disclosure.

FIG. 10(A), FIG. 10(B), FIG. 10(C), FIG. 10(D), FIG. 10(E), and FIG. 10(F) show experimental results for Richardson, TX site in which: FIG. 10(A), DAS sensing signal waterfall image, FIG. 10(B), DTS predictions plot, FIG. 10(C), DAS predictions plot, and FIG. 10(D), FIG. 10(E) and FIG. 10(F), MH/HH illustrations, while FIG. 10(G), FIG. 10(H), FIG. 10(I), FIG. 10(J), FIG. 10(K), and FIG. 10(L) show experimental results for Long Beach Island, NJ site in which: FIG. 10(G), DAS sensing signal waterfall image, FIG. 10(H), DTS predictions plot, FIG. 10(I), DAS predictions plot, and FIG. 10(J), FIG. 10(L) and FIG. 10(L), MH/HH illustrations, according to aspects of the present disclosure.

FIG. 11(A), FIG. 11(B), FIG. 11(C), and FIG. 11(D) show: FIG. 11(A), a plot and inset illustration of manhole condition diagnostics; FIG. 11(B), FIG. 11(C), and FIG. 11(D) are a pair of plots showing illustrative test beds in Richardson, TX (left) and Long Beach Island, NJ (Right) according to aspects of the present disclosure.

FIG. 12 is a schematic diagram showing an illustrative computer system in which methods of the instant disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing (DFOS) systems convert an optical fiber to an array of sensors distributed along the length of the optical fiber. In effect, the optical fiber becomes the array of sensos, while an interrogator generates/injects laser light energy into the optical fiber and senses/detects events along the optical fiber length from backscattered light.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration-can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

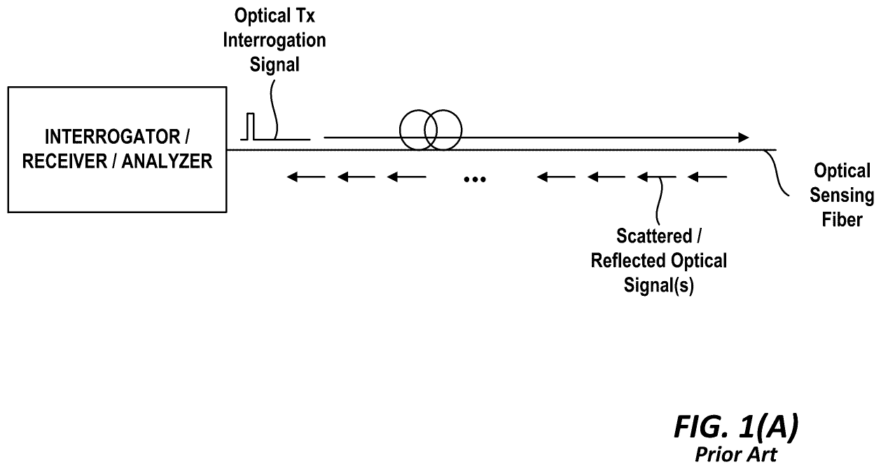

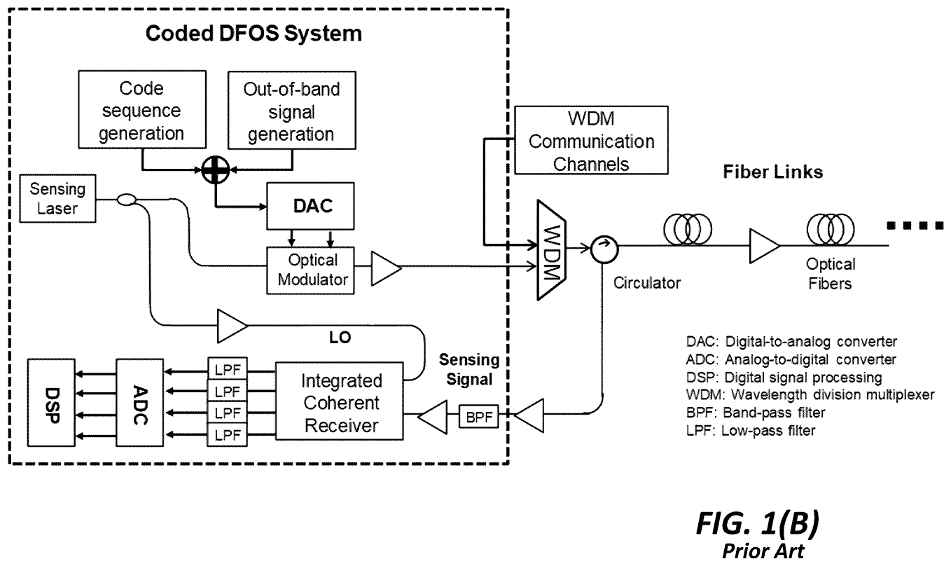

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects and/or analyzes reflected and/or backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As is known, acoustic signals are produced by numerous events, enabling humans to naturally learn various types of sounds through acoustic sensory experiences. Therefore, acoustic signals are one of the essential factors for real-time awareness of surrounding events, as well as image and video data.

For example, the detection of an explosion sound by our ears can immediately indicate an anomaly. Deploying numerous audio sensors, like electric microphones, over large areas can provide valuable acoustic information for anomaly detection and scene or event recognition. However, this approach is energy-intensive, and these devices may require batteries to operate.

One solution to this issue is to use a distributed fiber-optic sensor. This DFOS technology advantageously converts an optical fiber extending over 10 kilometers into a distributed sensor with a spatial resolution on the order of 1 meter. Specifically-as noted above-a sensor employing phase-sensitive optical time-domain reflectometry (Phase-sensitive OTDR), also known as a Distributed Acoustic Sensor (DAS), can convert mechanical dynamic strains on the fiber, caused by acoustic signals, into phase changes in Rayleigh backscattered light. Consequently, this allows for the monitoring of local acoustic events over very large geographic areas using the optical fiber. Of further advantage, the optical fiber may be a telecommunications-carrying optical fiber, thereby allowing telecommunications traffic and DFOS - simultaneously.

Optical fiber networks, serving as the communication backbone, are extensively and densely deployed worldwide. The widespread of optical fiber infrastructures that telecom carriers have constructed over the past 30 years has been designed accommodating the surge in internet traffic and to facilitate the interconnections of 5G and future networks among cities, town, homes, and data centers.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

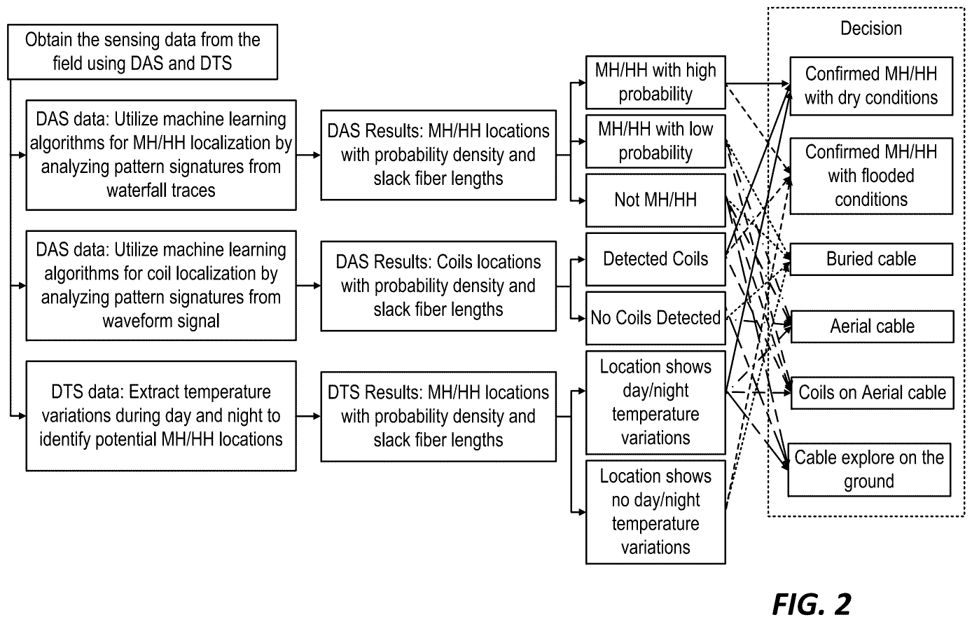

FIG. 2 is a schematic flow diagram showing illustrative overall procedure of integrated DFOS/DAS/DTS system and method according to aspects of the present disclosure. With reference to that figure, one may observe illustrative key features and their relationship and/or sequences according to aspects of the present disclosure.

As illustratively shown, DAS and DTS sensing data is acquired from DFOS operation and the subsequent processing and utilization of the DAS and DTS sensing data so acquired. As shown, DAS data is utilized in conjunction with machine learning algorithms for MH/HH localization by analyzing pattern signatures from DAS waterfall traces and DAS results including MH/HH locations with probability density and slack fiber lengths are determined therefrom.

Additionally, using machine learning algorithms for coil localization to analyze pattern signatures from waveform signals are used to determine coil locations with probability density and slack fiber lengths.

Finally, DTS data is used to extract temperature variations during day/night periods to identify potential MH/HH locations and the MH/HH locations with probability density and slack fiber lengths are determined.

From these determined characteristics, further determinations may be made with respect to MH/HH existence, coil detections, day/night location temperature variations to made informed decisions about MH/HH dry/wet conditions, buried cables, aerial cables, and coils on aerial cables.

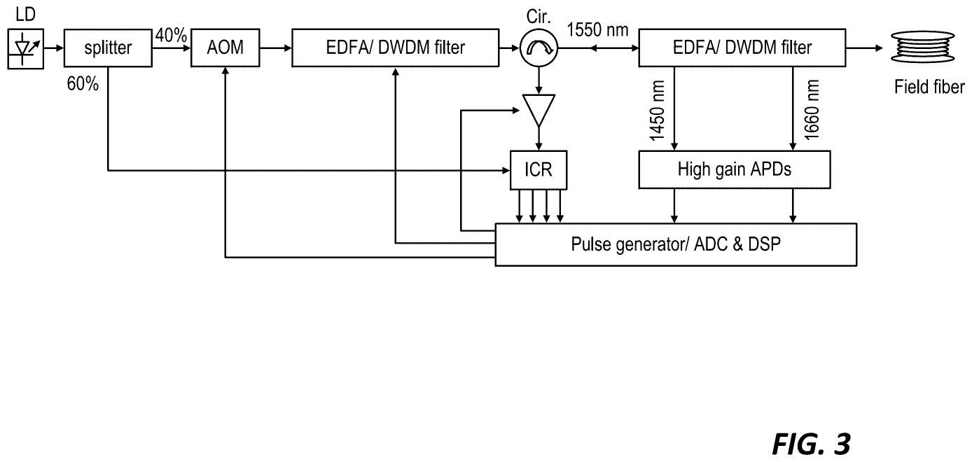

FIG. 3 is a schematic diagram showing illustrative integrated DAS/DTS system according to aspects of the present disclosure. By inspecting this illustrative diagram, one may observe the integrated architecture combining real-time DAS and real-time DTS into a single system. As those skilled in the art will understand and appreciate, both DAS and DTS functions can be performed using the same optical sensing fiber.

Operationally, a laser diode (LD) operates to generate laser light at a wavelength of 1550 nm, and the generated laser light signals are split such that a portion are directed to an integrated coherent receiver (ICR) where it serves as local oscillator (LO) for coherent detection of Rayleigh backscattering signals. Another portion of the generated and split laser light signals directed to a circulator and subsequently to an amplifier and filter and field optical sensor fiber. Raman backscattering signals, returned from the optical sensor fiber, at wavelengths of 1450 nm and 1660 nm, and are redirected to through a DWDM filter and subsequently detected by high-gain avalanche photodiodes (APDs). The detected data is then directed to an ADC for further signal processing.

By adjusting the peak power of the sensing probe via the EDFA, the system can activate either DAS or DTS through the ICR or APDs. At low peak power (<100 mW), Rayleigh backscattering signals are detected by the ICR, while Raman backscattering is too weak for APD detection. At high peak power (>1 W), Raman backscattering is detected, but the ICR becomes saturated.

Those skilled in the art will understand and appreciate that the ICR is a critical component of advanced DFOS systems—and in particular DAS systems—which may employ coherent optical time domain reflectometry (C-OTDR) and its primary function is to perform highly sensitive optical-to-electrical conversion and signal mixing.

As noted, the ICR is a sophisticated optoelectronic device that performs the detection stage of the DAS process. Its functions include:

Coherent Detection: The ICR mixes the faint backscattered light signal (from the optical sensor fiber) with a strong, known laser signal (the local oscillator, or LO). This process is known as heterodyne detection or coherent detection. This mixing greatly amplifies the signal-to-noise ratio [symbol] SNR [symbol] , allowing the system to detect extremely weak, phase-shifted light from the long fiber, which is crucial for DAS.

I/Q Demodulation: The integrated design of the ICR contains optical hybrids and balanced photodetectors to separate the incoming light into in-phase (I) and quadrature (Q) electrical signals. This I/Q data contains the full complex-valued information (amplitude and phase) of the backscattered light. The phase information is what directly relates to the strain/vibration (acoustic signal) on the fiber.

Polarization Diversity: Modern ICRs are often “polarization-diversity” devices. The Rayleigh backscattered light's polarization can randomly fluctuate and fade over the length of the fiber (known as polarization fading). The ICR addresses this by splitting the signal into two orthogonal polarizations (X and Y) and processing both. This ensures a stable, reliable signal regardless of the fiber's polarization state, overcoming a major challenge in earlier DAS systems.

In this specific system description (Rayleigh backscatter at nm captured by an ICR, processed through DSP for DAS function), the ICR is the bridge between the optical domain and the electrical/digital domain. By providing a stable, high-fidelity electrical signal ready for digital processing, the ICR is the key component that enables the high sensitivity and long-range operation of modern phase-sensitive DFOS/DAS system.

When operated, the overall method involves the following procedures and parameters.

### Step 1: Receiving Sensing Data

i) Adjust the EDFA power to collect the sensing data.
ii) Use low peak power (<100 mW) of the sensing signal for DAS data collection and high peak power (>1 W) for DTS data acquisition.
iii) Although the architecture supports real-time integrated sensing, both DAS and DTS data can be gathered every 60 minutes by modulating the peak power of the sensing probe.

### Step-2: DAS Data Analyzing

i) Analyze waterfall trace data to identify potential MH/HH locations with slack fibers.
ii) Use phase correlation analysis from waveform signals to detect fiber coils and determine their lengths.

### Step-3: Dts Data Analyzing

i) Compare day/night DTS data to identify locations exhibiting temperature variation.
ii) Read Absolute Temperature for Each Location.

### Step-4: Correlation Between Sensing Results to Determinate the MH/HH Locations/Conditions and Anomaly Events

i) Correlate DAS and DTS results to accurately determine MH/HH locations, their conditions (e.g., flooded, dry, frozen), and any detected anomalies.

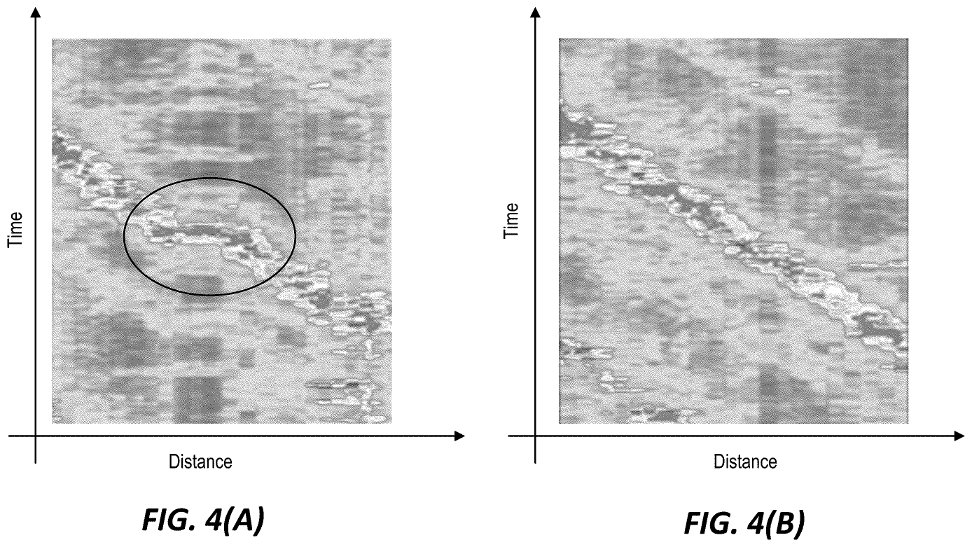

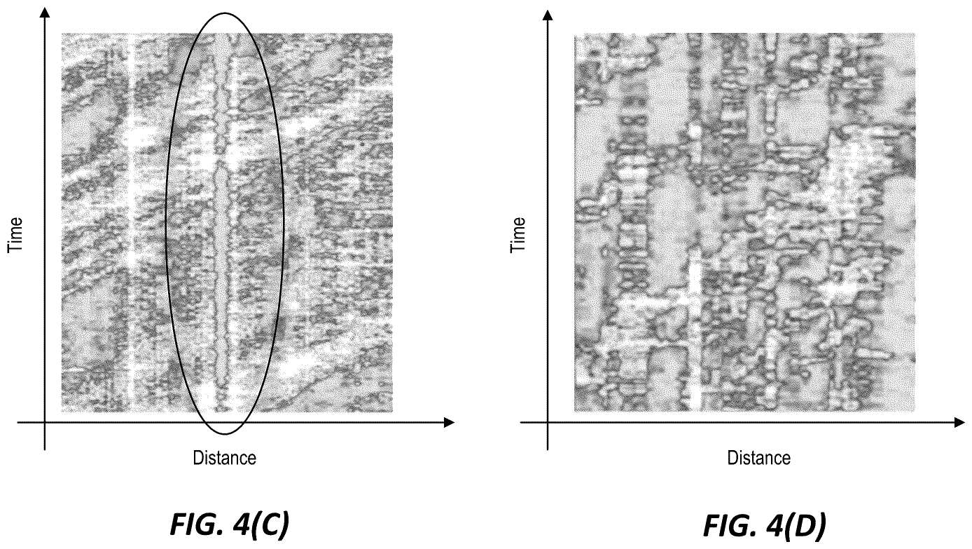

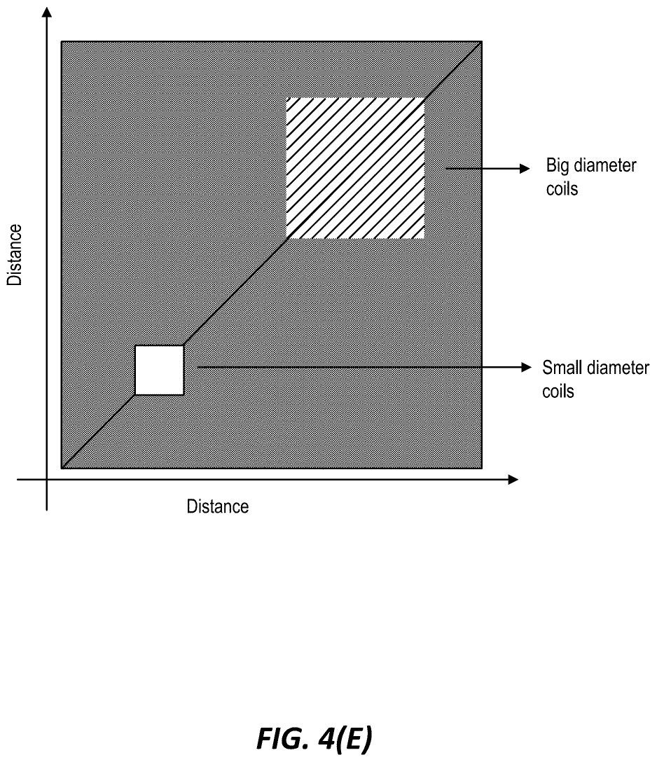

FIG. 4(A), FIG. 4(B), FIG. 4(C), FIG. 4(D), and FIG. 4(E), series of illustrations of: FIG. 4(A)-4(D) waterfall images; and FIG. 4(E) phase correlation from waveform signals according to aspects of the present invention.

As may be observed, FIG. 4(A)-(D) display the signatures as waterfall images, while FIG. 4(E) shows the signature extracted from waveform signals through phase correlation analysis. In FIG. 4(A) and 4(C), MM/HH is detected, whereas FIG. 4(B) and 4(D) show locations without MH/HH. The horizontal line signature shown in FIG. 4(A), between a single traffic trajectory, and the empty space in FIG. 2(C), between ambient noise, can serve as labeled data for CNN training to identify MH/HH locations along the monitored field fiber. Simultaneously, by analyzing phase correlations from the waveform signals, the fiber optic coils and their lengths can be determined.

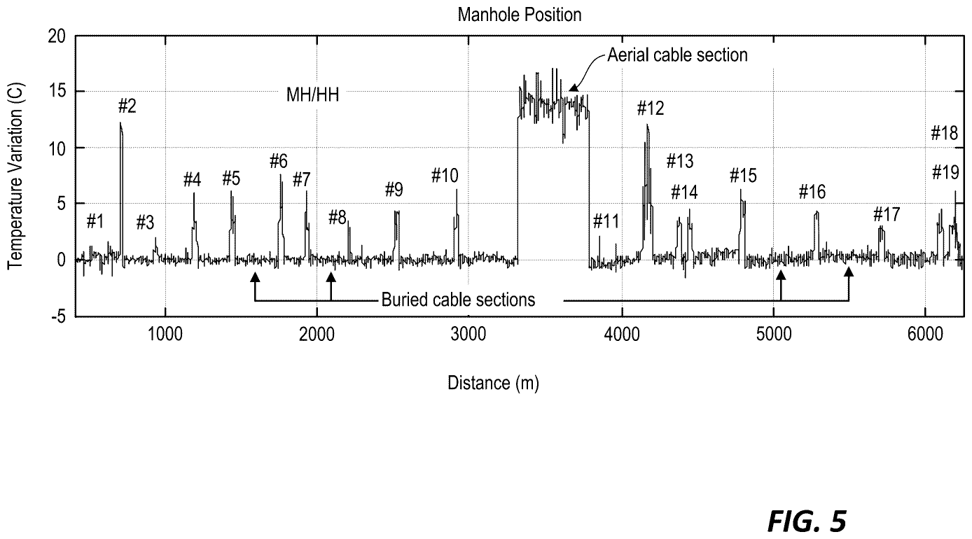

FIG. 5 is a plot of Manhole Position vs Temperature Variation vs Distance of observed MH/HH locations determined by DTS according to aspects of the present disclosure. As illustrated in this figure, extracted data from the DTS are shown, comparing temperatures during the day (approximately 2 PM, when temperatures are highest) and at night (approximately 2 AM, when temperatures are lowest). After extraction, temperature variations can be observed. These locations correspond to either MH/HH or aerial cable sections. In a dry MH/HH, day/night temperature variations are noticeable, whereas this variation is not observed in flooded MH/HHs due to the stable temperature during day and night. Locations without temperature variations represent buried cable sections, where stable ground temperatures are maintained at depths greater than 1.5 meters.

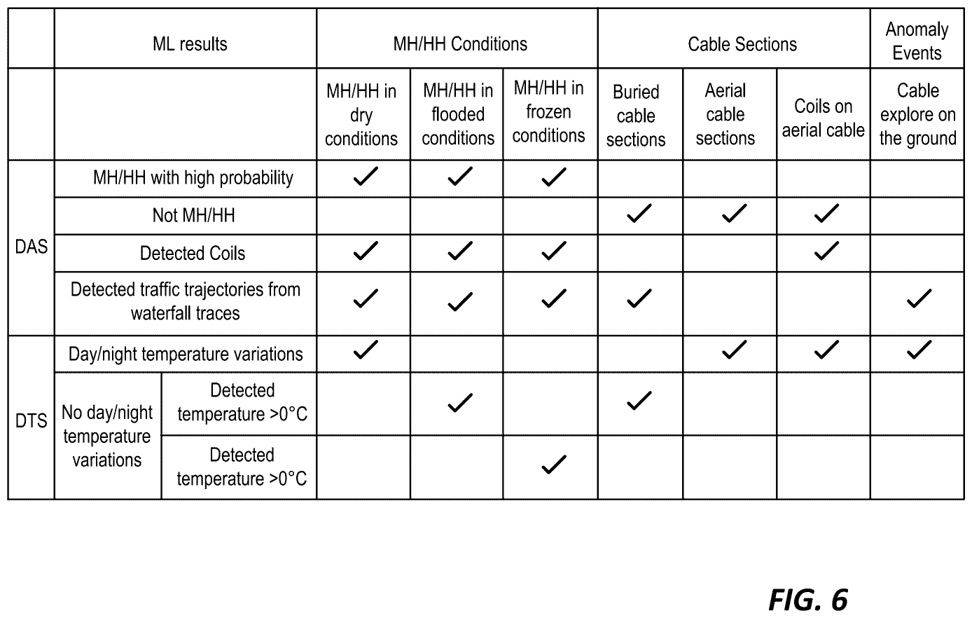

FIG. 6 is a tabular presentation of ML results, MH/HH Conditions, Cable Sections, and Anomaly Events for DAS and DTS according to aspects of the present disclosure.

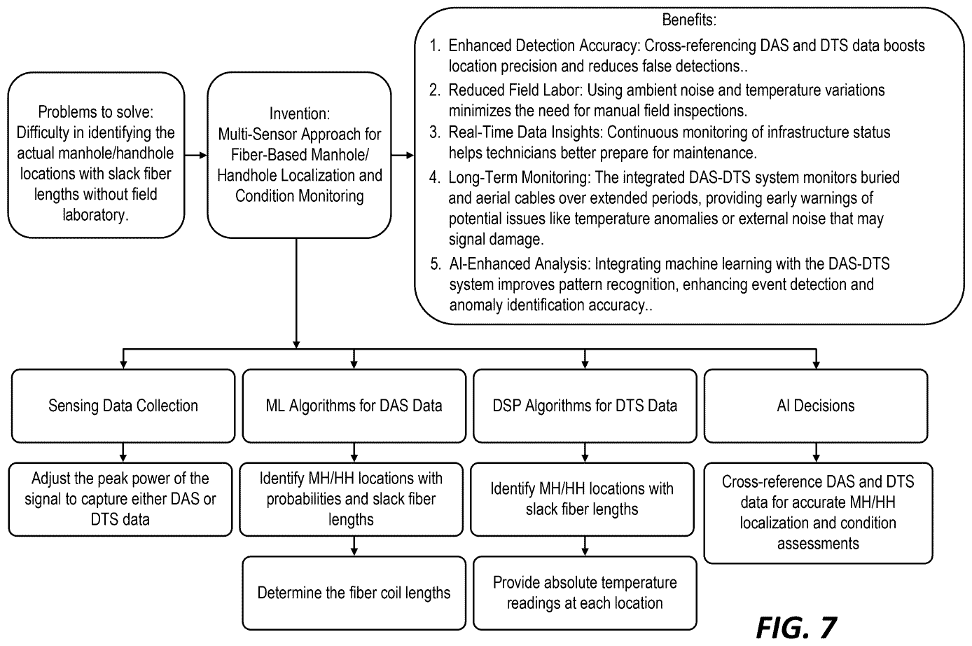

FIG. 7 shows an illustrative feature diagram in hierarchical format of an integrated DFOS/DAS/DTS system and method according to aspects of the present invention. As illustratively diagrammed in that figure, our inventive multi-sensor approach for fiber-based manhole/handhole localization and condition monitoring is described with respect to problems solved, component processes, and benefits.

### Experimental Field Trial

In this disclosure, we have described an inventive integrated DFOS DAS/DTS system and method for manhole/hand hole (MH/HH) localization, condition diagnostics and anomaly detection. Our disclosed system and method advantageously enhances manhole localization accuracy from 80% to 94.7% compares to using standalone DAS or DTS systems. Our method has been validated on two Verizon test beds in Texas and New Jersey, demonstrating its ability to accurately localize MHs, assess conditions, and supporting anomaly monitoring for cable damage prevention.

### Experimental Field Trial Setup and Results

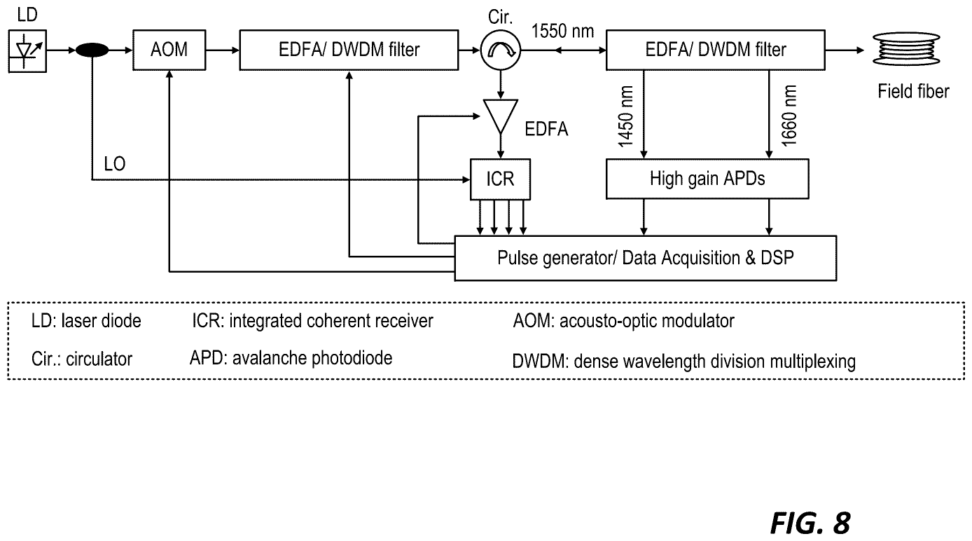

FIG. 8 is a schematic diagram showing illustrative experimental setup up an integrated DAS/DTS system according to aspects of the present disclosure.

As illustrated, the experimental setup of integrated DAS/DTS system is like the general configuration show and described previously. A 1550-nm laser diode (LD), followed by an acousto-optic modulator (AOM), EDFA and DWDM filter, generates sensing pulses with 40 ns width. The system operates at a sampling rate of 125 MHz, utilizing short optical pulses and fast on-chip processing to achieve an equivalent sensor resolution as fine as 1 meter. Both Rayleigh and Raman backscattering signals are returned to the field optical sensor fiber and separated by the DWDM filter.

The Rayleigh backscatters at 1550 nm are captured by an ICR, processed through DSP for the DAS function, while high-gain APDs receive Raman backscatters at 1450 nm and 1660 nm, feeding into DSP for DTS functionality. By adjusting the peak power of the sensing probe, the system can selectively activate DAS at low peak power (<100 mW) and DTS at high peak power (>1 W).

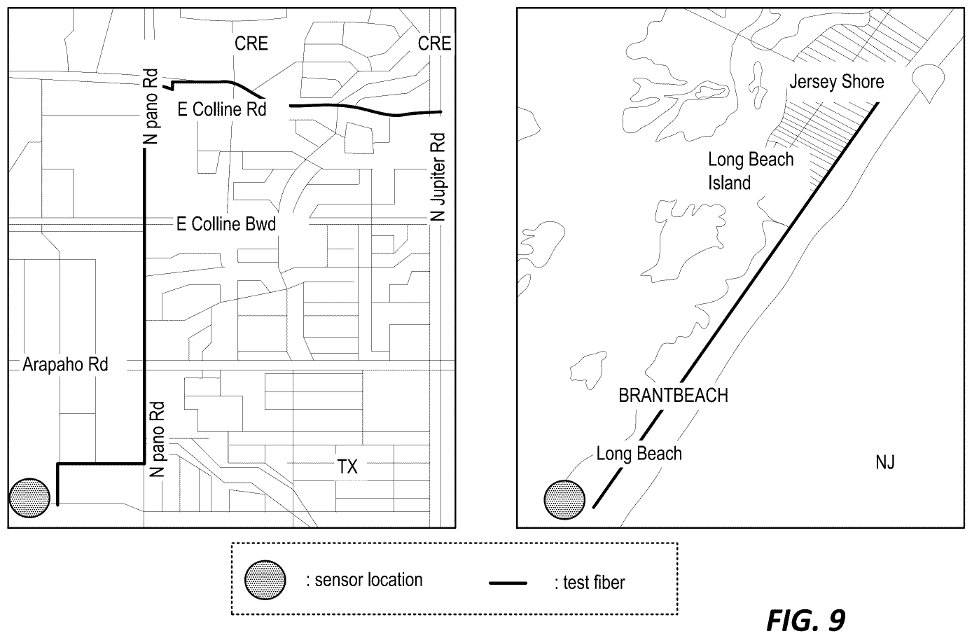

FIG. 9 are a pair of plots showing illustrative test beds in Richardson, TX (left) and Long Beach Island, NJ (Right) according to aspects of the present disclosure.

In those test beds, most cables were buried at depths of 36-48 inches (0.9-1.2 m) in TX and 40-60 inches (1-1.5 m) in NJ. These locations represent two different environmental conditions: the MH in TX is typically dry, whereas those in LBI are often flooded. In this study, we employed two algorithms: one analyze the temperature variations (ΔT) in DTS data, and a machine learning (ML)based approach for processing DAS signals.

To capture temperature variations, data was analyzed during the warmest part of the day (˜2 pm) and the coolest part of the night (˜2 am). These windows represent peak thermal fluctuations, providing essential data for analysis. In this context, dry MH and aerial cable sections with fiber lengths are identified, while buried cables remain unaffected due to the stable underground temperature, showing no significant temperature variations.

We explored ML approaches for MH localization using ambient noise captured from DAS. With location-level labels (MH vs. non-MH) efficiently obtained from field inspections, an ML model trained on DAS data can be applied to (1) same-route verification and cross-sensor MH status diagnosis, and (2) cross-route generalization to a new route.

DAS ambient data is considered weakly labeled that contain discriminative information. One challenge encountered is the variability in the witness rate (WR)—the rate at which useful vibration pattern emerges—across time and location, as MH are harder to distinguish during quiet midnight hours by traffic vibrations.

To address this issue, we adopted a top-K data selection scheme, selecting patches with the highest total vibration level at each location (with K=50 per day in our experiments). While MH localization has been treated as an image classification problem, we employ a new image segmentation-based formulation in which the label of each pixel in the waterfall patch is predicted.

In our experiments, the input size of waterfall patch is 400×256, and the output is a binary image of the same size, with equal values per column indicating the location label. This choice has several advantages. First, it avoids the issue of selecting an inappropriate window length, which could result in either partial MH or multiple MHs in the same window. Second, it effectively leverages contextual information, as the label prediction is informed by neighboring locations and spatiotemporal patterns within a large window. Although predicting an output matrix for every row in the same column seems redundant, this formulation introduces an inductive bias in the positional correspondence between input and output pixels, which can be distilled via auto-encoding and facilitate learning.

We used a lightweight U-Net model to exploit spatial-temporal dependencies in the waterfall patches, based on an encoder-decoder architecture with skip connections. The model comprises 4 down sampling blocks with increasing channels from 16 to 256, followed by 4 up sampling blocks that restore the resolution. The final output uses a sigmoid activation to produce a probabilistic segmentation map. Location-level predictions are derived by aggregating per-pixel predictions across multiple signals and patches. To bridge the gap between different routes, we implement adaptive normalization: clipping each waterfall patch at the 0.95 quantile and quantizing it into 256 levels. Our method demonstrates zero-shot cross-route generalization performance, achieving AUC scores of 0.8463(TX to LBI) and 0.8631 (LBI to TX) based on data collected over multiple days.

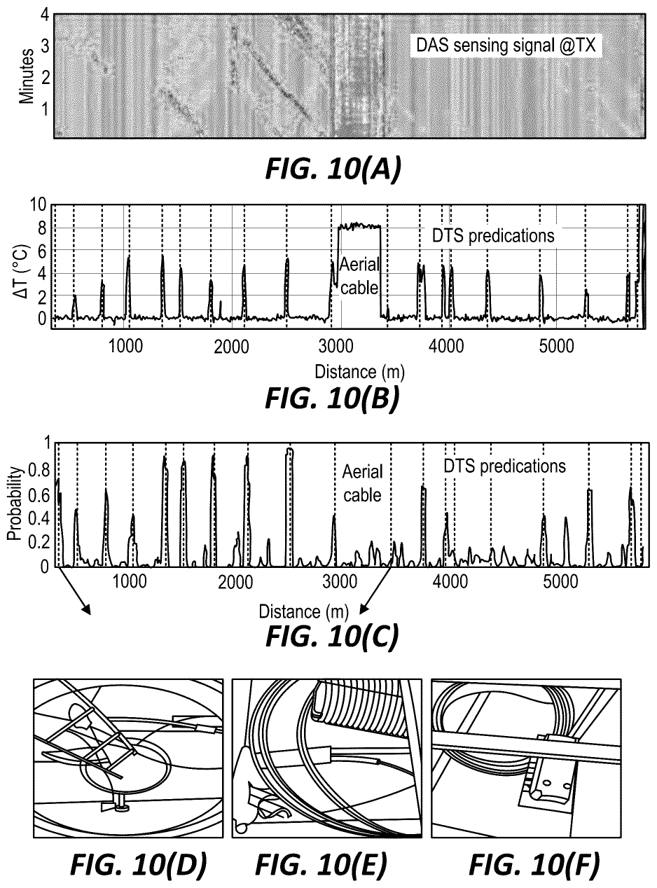

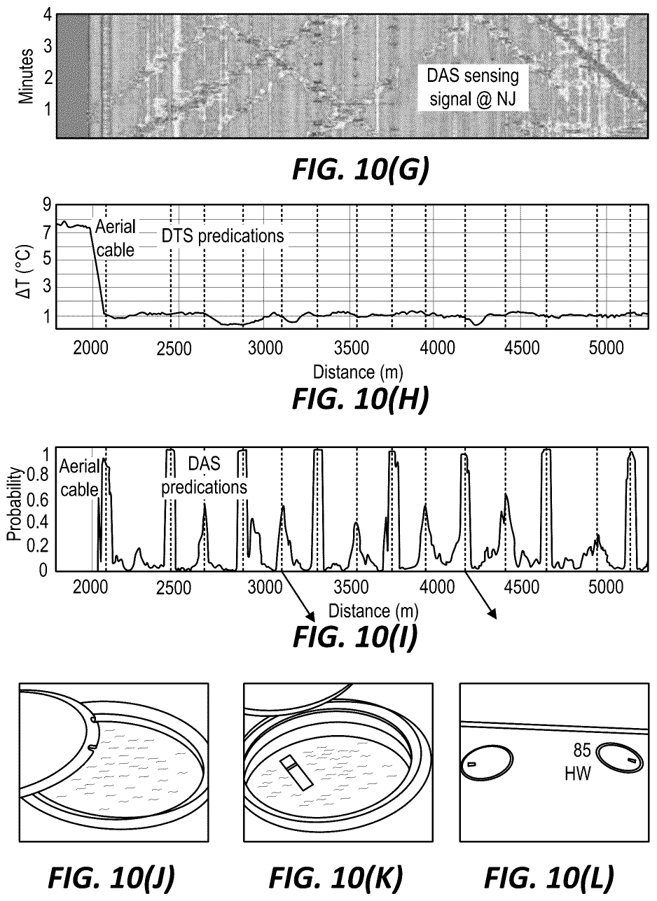

FIG. 10(A), FIG. 10(B), FIG. 10(C), FIG. 10(D), FIG. 10(E), and FIG. 10(F) show experimental results for Richardson, TX site in which: FIG. 10(A), DAS sensing signal waterfall image, FIG. 10(B), DTS predictions plot, FIG. 10(C), DAS predictions plot, and FIG. 10(D), FIG. 10(E) and FIG. 10(F), MH/HH illustrations, while FIG. 10(G), FIG. 10(H), FIG. 10(I), FIG. 10(J), FIG. 10(K), and FIG. 10(L) show experimental results for Long Beach Island, NJ site in which: FIG. 10(G), DAS sensing signal waterfall image, FIG. 10(H), DTS predictions plot, FIG. 10(I), DAS predictions plot, and FIG. 10(J), FIG. 10(L) and FIG. 10(L), MH/HH illustrations, according to aspects of the present disclosure.

The experimental results for MH localization predictions are presented in the figure include DAS waterfall traces, predictions from DTS, and DAS, with the actual MH locations marked. The test route in TX spans 5.8 km, with 1 km of aerial cable around 3.2 km. By setting thresholds of ΔT=2° C. and 0.45 of DAS prediction, 17 and 15 manholes were identified out of a total of 19, resulting in detection rates of 89.5% and 79%, respectively.

On the TX route, cross-referencing DAS and DTS data improve the detection rate to 94.7%. The figure also presents diagram illustrations of MHs along the route. For the first MH, DTS failed to detect it as the monitoring cable was fully submerged, leading to no ΔT due to the stable water temperature. Both DAS and DTS missed another MH following the aerial cable section, attributed to short slack fibers and partial water presence inside the MH, which reduced ΔT and resulted in low prediction probabilities from DAS.

Using the same trained ML engines from TX to test the NJ route produced the result shown. This route spans 5.2 km, with an aerial cable covering the first 2 km. The DAS prediction rate was 93% with a threshold of 0.45. However, no MHs could be detected via DTS in LBI due to the consistently flooded conditions. Some MHs exhibit lower DAS prediction possibilities because they are located farther from traffic, leading to limited vibration detection. However, since ambient DAS data is abundant, incorporating additional datasets could potentially enhance performance.

As will be appreciated by those skilled in the art, our inventive system and method is not only valuable for MH localization but also for condition diagnostics and anomaly detection to help prevent cable damage.

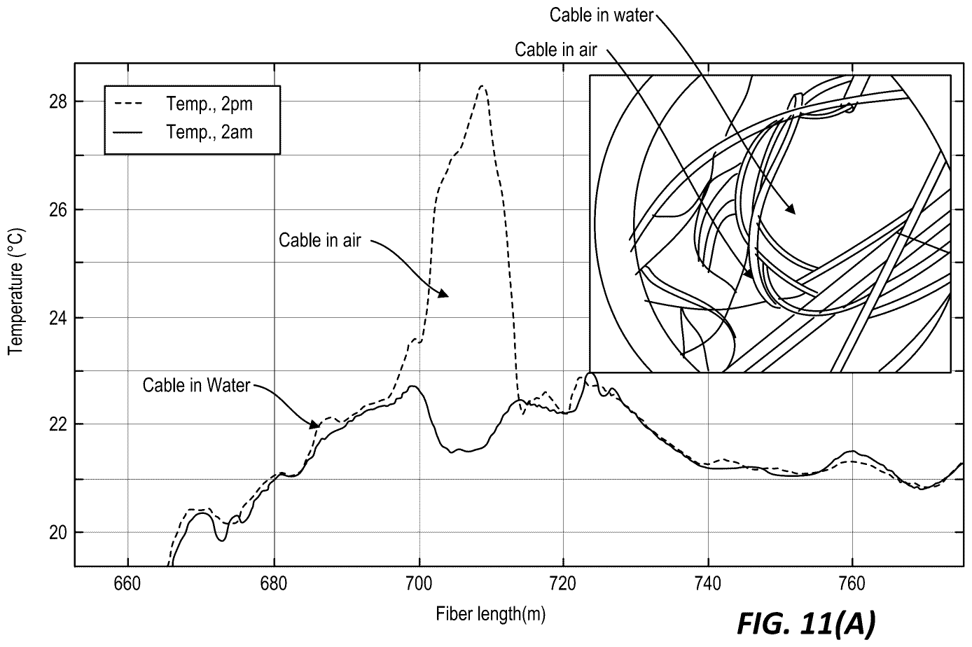

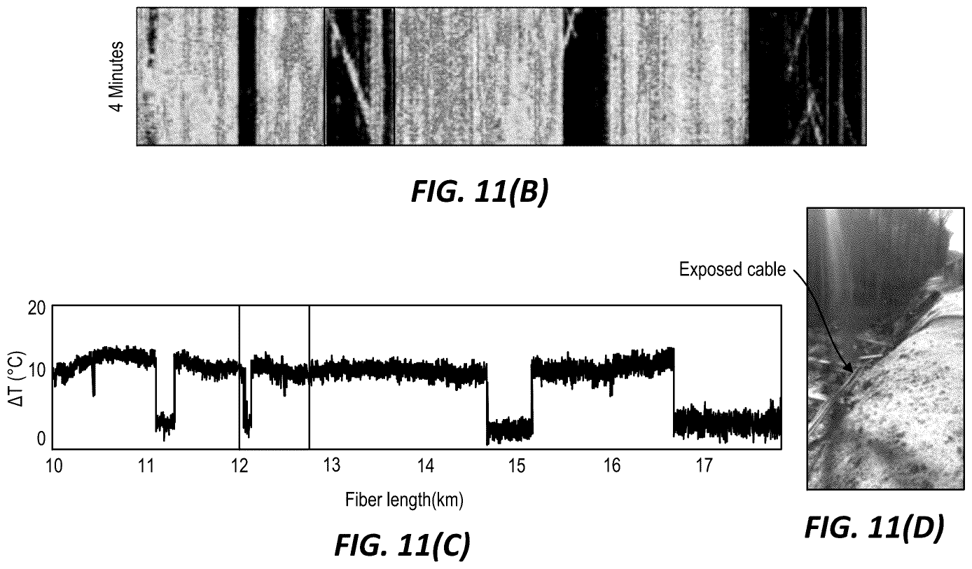

FIG. 11(A), FIG. 11(B), FIG. 11(C), and FIG. 11(D) show: FIG. 11(A), a plot and inset illustration of manhole condition diagnostics; FIG. 11(B), FIG. 11(C), and FIG. 11(D) are a pair of plots showing illustrative test beds in Richardson, TX (left) and Long Beach Island, NJ (Right) according to aspects of the present disclosure.

FIG. 11(A) illustrates an enlarged DTS result of a MH where the cable is both submerged in water and exposed to air. By continuously monitoring these conditions, the system can provide real-time feedback to field technicians, ensuring they are equipped with the appropriate tools for maintenance, improving operational efficiency and response times. Even during the winter seasons, the frozen MH can be identified by this scheme. FIG. 11(B) and 11(C) present DAS waterfall traces and DTS temperature variations for identifying cable anomalies. In the 12-12.8 km section of the route (highlighted in orange), DTS detected a ΔT=10° C., typically indicating aerial cable sections. However, DAS detected traffic patterns and behavior more typical of buried cables. Cross-referencing these results suggested that the cable might have fallen from its poles or was otherwise exposed. A field inspection (FIG. 11(D)) confirmed the cable had indeed fallen to the ground due to construction activities and was left unprotected. Early identification of such anomalies can help prevent potential cable damage.

Those skilled in the art will appreciate the effectiveness of our integrated DAS/DTS architecture for manhole localization, condition diagnostics, and anomaly detection. Our approach significantly improves localization accuracy from 80% to 94.7% by cross-referencing DAS and DTS data, surpassing the capabilities of standalone systems. Field trials conducted in TX and NJ validate this method, highlighting its adaptability to different environmental conditions, such as dry and flooded manholes. Furthermore, the system's ability to provide real-time feedback to technicians ensures proactive maintenance, reducing the risk of cable damage. These results confirm that this integrated fiber sensing system and method is a solution for enhancing the operational reliability of telecom networks, particularly for 5G infrastructure and beyond.

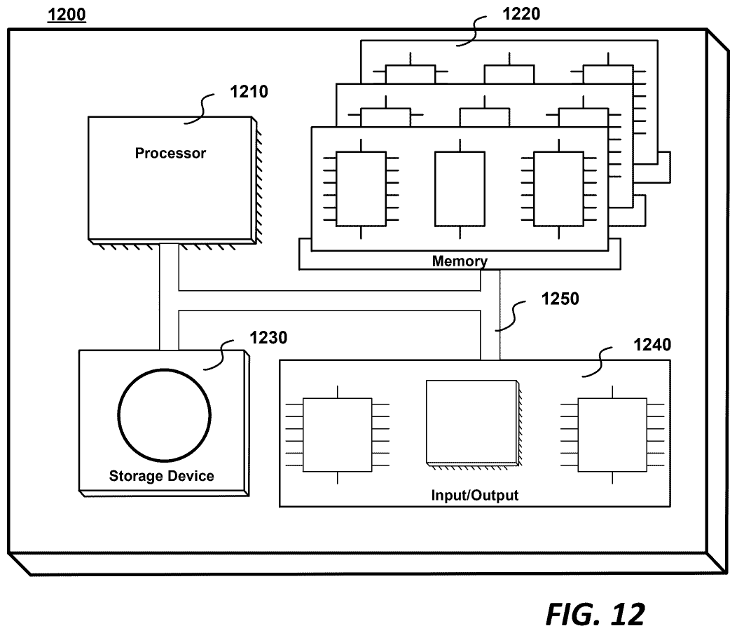

Finally FIG. 12 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 1200 as stored program control instructions.

Computer system 1200 includes processor 1210, memory 1220, storage device 1230, and input/output structure 1240. One or more input/output devices may include a display. One or more busses 1250 typically interconnect the components, 1210, 1220, 1230, and 1240. Processor 1210 may be a single or multi core. Additionally, the system may include accelerators etc., further comprising a system on a chip.

Processor 1210 executes instructions in which embodiments of the present disclosure may comprise steps described in one or more of the Drawing figures. Such instructions may be stored in memory 1220 or storage device 1230. Data and/or information may be received and output using one or more input/output devices.

Memory 1220 may store data and may be a computer-readable medium, such as volatile or non-volatile memory. Storage device 1230 may provide storage for system 1200 including for example, the previously described methods. In various aspects, storage device 1230 may be a flash memory device, a disk drive, an optical disk device, or a tape device employing magnetic, optical, or other recording technologies.

Input/output structures 1240 may provide input/output operations for system 1200.

At this point, those skilled in the art will understand that while we have presented our inventive concepts and description using specific examples, our invention is not so limited. Accordingly, the scope of our invention should be considered in view of the following claims.

1. An integrated distributed fiber optic sensing (DFOS) system for manhole/handhole (MH/HH) localization and condition monitoring, comprising:
a distributed acoustic sensing (DAS) receiver configured to receive Rayleigh backscattering signals as DAS data;
a distributed temperature sensing (DTS) receiver configured to receive Raman backscattering signals as DTS data;
a processor configured to:
identify potential MH/HH locations from the received DAS data;
identify locations with temperature variations from the received DTS data; and
correlate the DAS location and the DTS temperature variation data to determine the MH/HH location and condition status.

2. The system of claim 1, wherein the DAS receiver is configured to receive Rayleigh backscattering signals when a sensing signal peak power is <100 mW.

3. The system of claim 2, wherein the DTS receiver is configured to receive Raman backscattering signals when a sensing signal peak power is >1 W.

4. The system of claim 1, wherein the DAS receiver includes an Integrated Coherent Receiver (ICR).

5. The system of claim 1, wherein the DTS receiver includes a Dense Wavelength Division Multiplexing (DWDM) filter and high-gain Avalanche Photodiodes (APDs).

6. A method for localizing and diagnosing the condition of a manhole or handhole (MH/HH) in a fiber optic network, the method comprising:
collecting Rayleigh backscattering signals from a field optical fiber as Distributed Acoustic Sensing (DAS) data;
analyzing the DAS data using a machine learning model to generate a DAS localization probability for candidate MH locations;
collecting Raman backscattering signals as Distributed Temperature Sensing (DTS) data from the same field optical fiber to measure temperature variations;
determining a condition status of the MH by correlating the DAS localization probability with the measured temperature variations.

7. The method of claim 6, further comprising:
identifying the MH as flooded when the DAS localization probability is high when the measured temperature variation is substantially zero.

8. The method of claim 6, further comprising:
identifying the MH as dry when the DAS localization probability is high and the measured temperature variation is greater than a predetermined threshold.

9. The method of claim 4 wherein the machine learning model is a U-Net model using an image segmentation-based formulation to predict location labels from DAS waterfall traces.

10. The method of claim 6, further comprising:
identifying a field optical cable anomaly by correlating a high measured temperature variation determined by DTS with a traffic pattern indicative of buried field optical cable determined by DAS, indicating an exposed or fallen field optical cable.

11. A non-transitory computer-readable medium storing instructions that, when executed by a processor, perform the method of claim 6.
